(19) United States
(12) Patent Application Publication
(10) Pub. No.: US 2009/0308994 A1
(43) Pub. Date: Dec. 17, 2009

(54) PORTABLE APPARATUS AND METHOD FOR SUSPENDING GAME OR OTHER OBJECTS ABOVE THE GROUND

(76) Inventor: Richard Alan Moore, Rockford, MI (US)

Correspondence Address: Waters & Associates, 161 Ottawa Ave., N.W., 305B WATERS BUILDING, Grand Rapids, MI, 49503, US

(21) Appl. No.: 12/481,304

(22) Filed: Jun. 9, 2009

Related U.S. Application Data
(60) Provisional application No. 61/061,765, filed on Jun. 16, 2008.

(51) Int. Cl. A22C 15/00

(52) U.S. Cl. 248/229.17; 452/185

(57) ABSTRACT

A portable support apparatus for supporting game or other objects above the ground between spaced vertical columns comprises a support bracket attached by non-elastic straps to each column and a cross bar extending between the brackets. Each bracket includes a vertical back plate that rests flat against the vertical column and a vertical support plate that extends outwardly from a front side of the support plate. A recess in an upper edge of the support plate serves as a cross bar rest. The back plate can include studs to reduce slipping. The cross bar rest can have a rectangular U-shape or a V-shape for a rectangular, round or angled cross bar. The bracket can be mounted at a skewed angle on the column so the cross bar fits snugly in the recess.

### CROSS REFERENCE TO RELATED APPLICATIONS

This application is based on and claims the filing priority of Applicant's co-pending provisional application No. 61/061,765, filed Jun. 16, 2008, the disclosure of which is incorporated by reference.

### BACKGROUND OF THE INVENTION

The present invention is directed to a portable hanging device. The invention is easily portable and can be adapted to fit a wide range of vertical support structures, such as trees or poles, for suspending game animals or other objects above the ground.

An object of the invention is to provide a mounting system that will not significantly damage the tree or pole to which it is attached.

Another object of the invention is to provide a bracket that can be employed with a wide variety of cross bars, from precut wood to metal bars and tree limbs or trunks that can be cut on site.

Yet another object of the invention is to provide a hanging device that will support a wide variety of objects, including but not limited to, game for dressing, camping equipment, a camping shower, outboard motors and any item that is desirable to be suspended off the ground.

Another object of the present invention is to provide a hanging device that can be used to suspend a number of separate objects above the ground at the same time.

### SUMMARY OF THE INVENTION

A portable support apparatus for a supporting game animals or other objects above the ground between two adjacent, spaced vertical columns comprises a set of at least two brackets attached by straps to separate support columns at a predetermined position above the ground. The brackets include a vertical back plate, the backside of which abuts the vertical column. A vertical support plate is attached along its rear edge to the back plate and extends outwardly therefrom. The support plate has a recess in an upper edge that is shaped to function as a cross bar rest for a cross bar. Flexible straps engage the brackets and hold the brackets at fixed positions above the ground by means of buckles that are tightened around the support column. A cross bar extends between the brackets and rests in the cross bar rests in the brackets, with the cross bar supporting objects suspended from the cross bar. The brackets may include studs for gripping the support column. The brackets can have round, triangular or square recesses to hold round logs or rectangular beams.

In one aspect of the invention, the back plates of the brackets include studs that engage the support columns and resist downward slipping of the support brackets on the support columns.

In one aspect of the invention, the brackets forming the cross bar rest compromise a rectangular U shaped recesses, with side edges of the recesses being spaced apart sufficiently to permit the cross bar to rest between the side edges. In another aspect of the invention, the recess is wider than the space between the side edges of the cross bar rest, such that the bracket can be mounted at a skewed angle on the vertical column so that side edges of the recess are spaced closely to the cross bar positioned in the cross bar rest.

In another aspect of the present invention, the recesses in the upper edges of the vertical support plates are V-shaped. This shape facilitates supporting a cross bar having an angular or round cross section, such as a log. The cross bar also may be a rectangular beam. The brackets and beams can be disassembled for transportation or storage.

In operation, the brackets are strapped to spaced trees or support columns, and a cross beam is mounted in the brackets so as to be suspended between the brackets. A rachet belt tightener can be used to tightly strap the brackets to the support members. Any number of things can be supported from the cross beams, including game animals taken during hunting and various appliances, such as outboard motors.

These and other features of the present invention will hereinafter appear, and for the purposes of illustration but not of limitation, preferred embodiments of the present invention are described below and shown in the impended drawings.

### BRIEF DESCRIPTION OF THE DRAWINGS

FIG. 1 is a perspective view of the invention mounted on two adjacent trees or poles, supporting a horizontal rectangular beam around which a circular chain has been placed.

FIG. 2 is a right side perspective view of the bracket of FIG. 1 wherein the bracket has a rectangular U-shaped cross bar rest in an upper edge.

FIG. 3 is a left side perspective view of the bracket of FIG. 1.

FIG. 4 is a right side perspective view of an alternate embodiment of the bracket with a V-shaped cross bar rest.

FIG. 5 is a left side perspective view of the bracket of FIG. 4.

FIG. 6 is a side perspective view showing a pair of the brackets of FIG. 4 mounted on poles.

FIG. 7 is an alternative view of the mounted bracket of FIG. 6 showing the ratchet tie-down.

FIG. 8 is a perspective view of the invention showing a bracket with a V-shaped cross bar rest supporting a circular tree trunk around which a hook strap is attached.

FIG. 9 is a perspective view of the invention showing a bracket with a V-shaped cross bar rest supporting a square beam around which a hook strap is attached.

FIG. 10 is a perspective view of the invention showing a bracket with a U-shaped cross bar rest mounted at an angle on a tree and supporting a rectangular beam on which an outboard boat motor is clamped.

FIG. 11 is a reverse perspective view of the embodiment of FIG. 10, showing the opposite side of the bracket.

FIG. 12 is a side view of pointed bolts employed in the present invention to prevent slippage when securing the bracket of the present invention on a vertical support member.

### DETAILED DESCRIPTION OF THE INVENTION

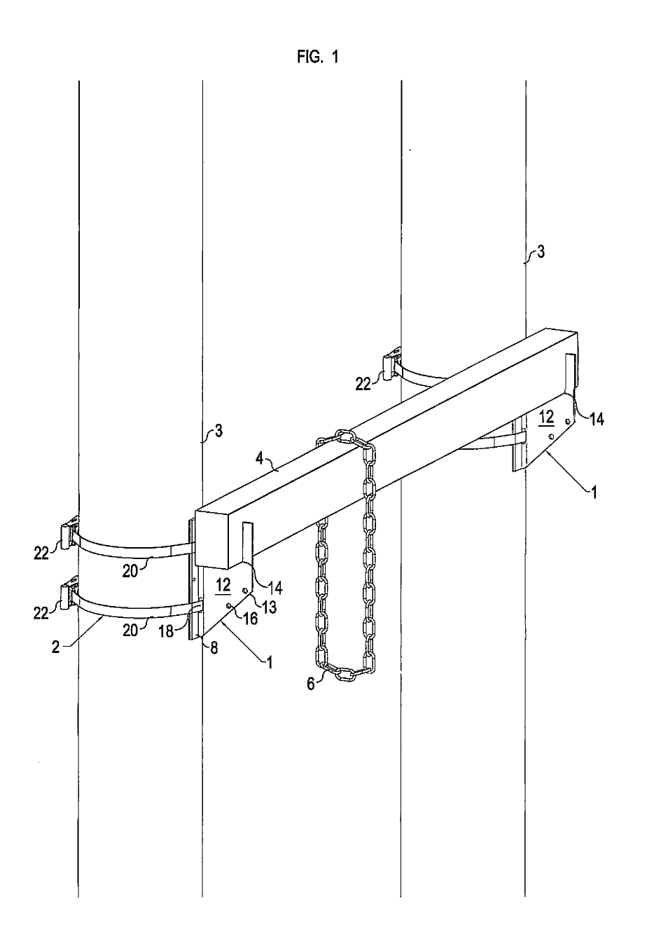

Referring to the drawings, an assembly is shown in FIG. 1 featuring a bracket 1 mounted on a tree (or pole) and securely fastened around the trunk 3 using two conventional ratchet tie-down straps 2, which typically are woven nylon or other fabric straps having a ratchet buckle that permits the strap to be tightened by pulling the strap through the buckle. The buckle can be released to release the straps. A similar bracket 1′ is mounted on an adjacent tree trunk 3′ at the same height. A cross bar in the form of a square or rectangular beam 4 rests horizontally in recesses or cross bar rests 14 and 14′ in upper edges of the two brackets.
A chain 6 is fastened around the beam to allow hanging of various light or heavy items.

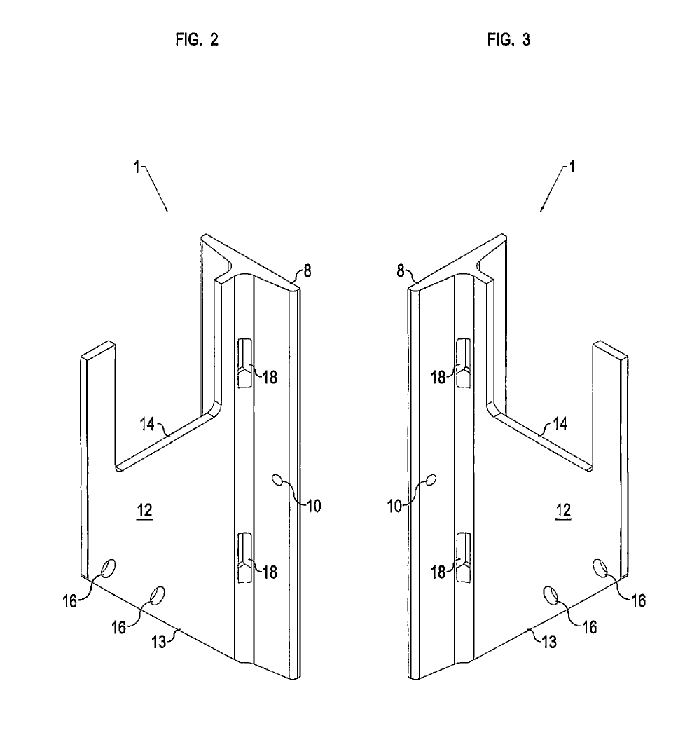

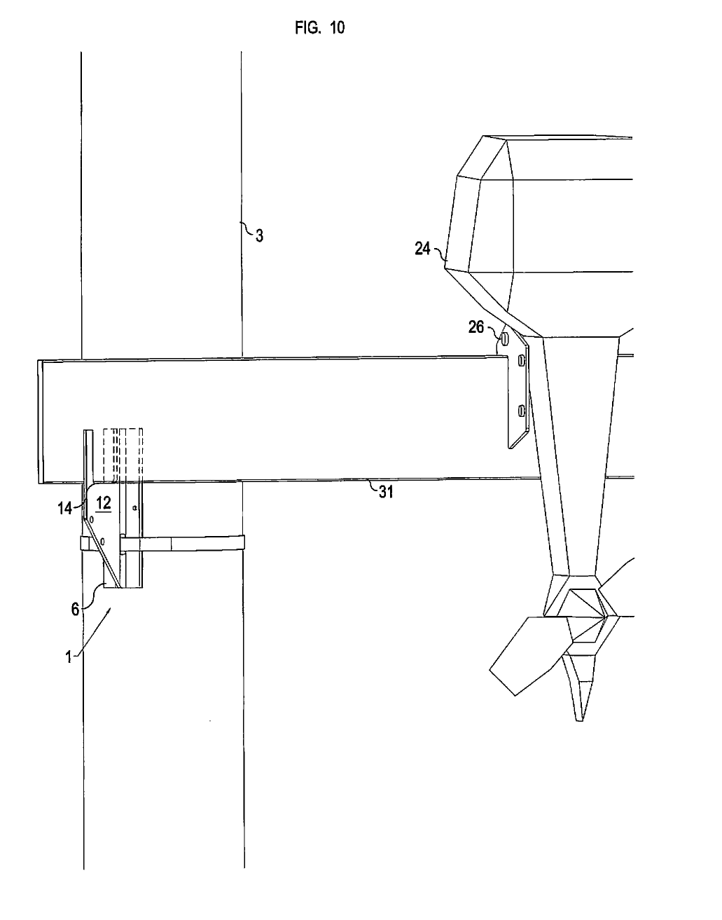

FIG. 2 and FIG. 3 show detailed views of bracket 1. Bracket 1 comprises a back plate 8 and a beam support plate 12 welded together at right angles. The plates can be made of metal and welded together. Aluminum is preferred because of weight and non-corrosion characteristics, but different materials can be used, including steel or plastic or composite materials. The bracket can be produced by extrusion instead of welding. The cross bar rest 14 of FIG. 1 is a recess formed in a rectangular U shape in the upper edge of the support plate. In this manner, square or rectangular beams can rest in the bracket without sliding laterally. The slot width desirably is sufficient to accommodate the largest rectangular or square beam contemplated and would typically be about four inches wide. As shown below and discussed with regard to FIG. 10, when a narrower rectangular beam is employed, the bracket can be rotated around the pole to a skewed angle until the vertical edges of the slot engage the sides of the beam in order to hold the sides of the beam upright. Two long vertical slots 18 positioned at the junction of the two perpendicular plates 8 and 12 allow the straps to pass through the bracket so the bracket can be supported by the straps. The beam support plate 12 has a lower edge 13 formed at an angle from its bottom to its middle. This eliminates a sharp corner and reduces the overall weight of the bracket without losing support strength. Two holes 10 have been drilled in the back plate 8 to allow the user to insert ¼ inch wide grabber bolts 28 as shown in FIG. 12. The bolts have pointed tips that engage a tree trunk to further prevent vertical slippage. Two holes 16 have been drilled in the support plate for mounting hooks, ropes, cables or other accessories.

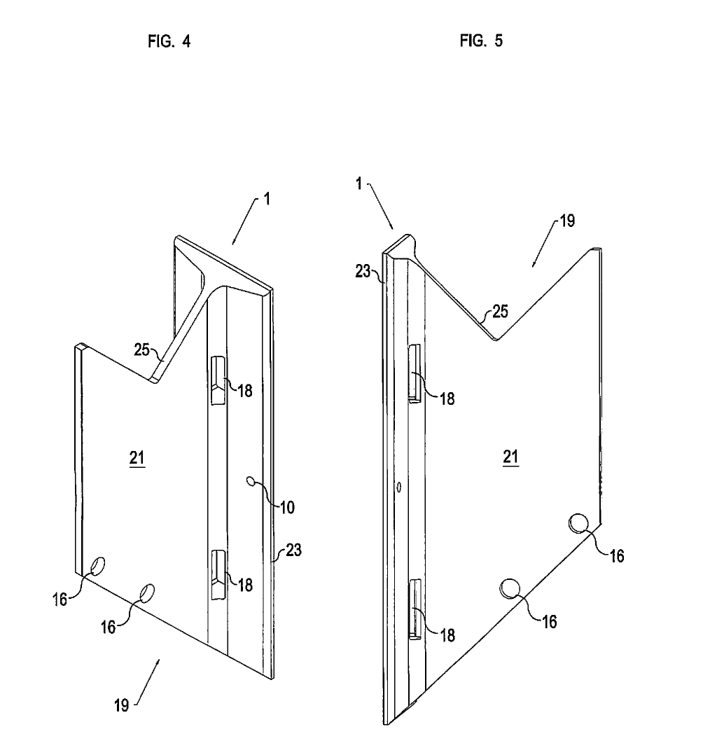

FIG. 4 and FIG. 5 show detailed views of another embodiment 19 of the invention. Parts that are the same as the previous embodiments are identified with the same numerals as the first embodiment. As in the previous embodiment a support plate 21 is mounted preferably at right angles to the middle of the front side of a back plate 23. In this embodiment, the cross bar rest 25 formed in the upper edge of support plate 21 is formed in a V shape desirably with a right angle, allowing the user to secure either a square beam or a round beam, such as a tree trunk. The V shape does not limit the permitted diameter of the cross bar.

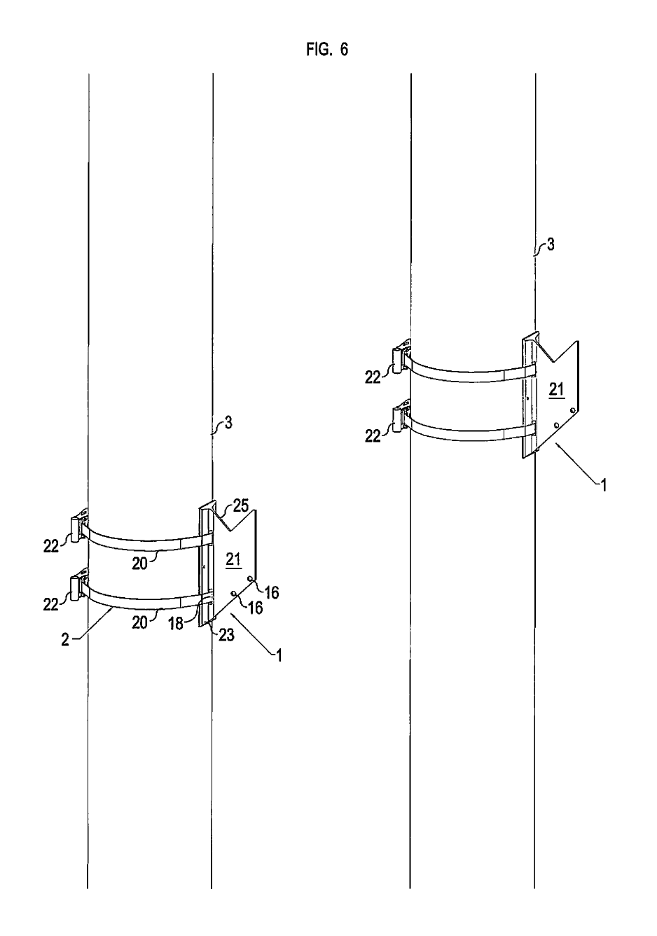

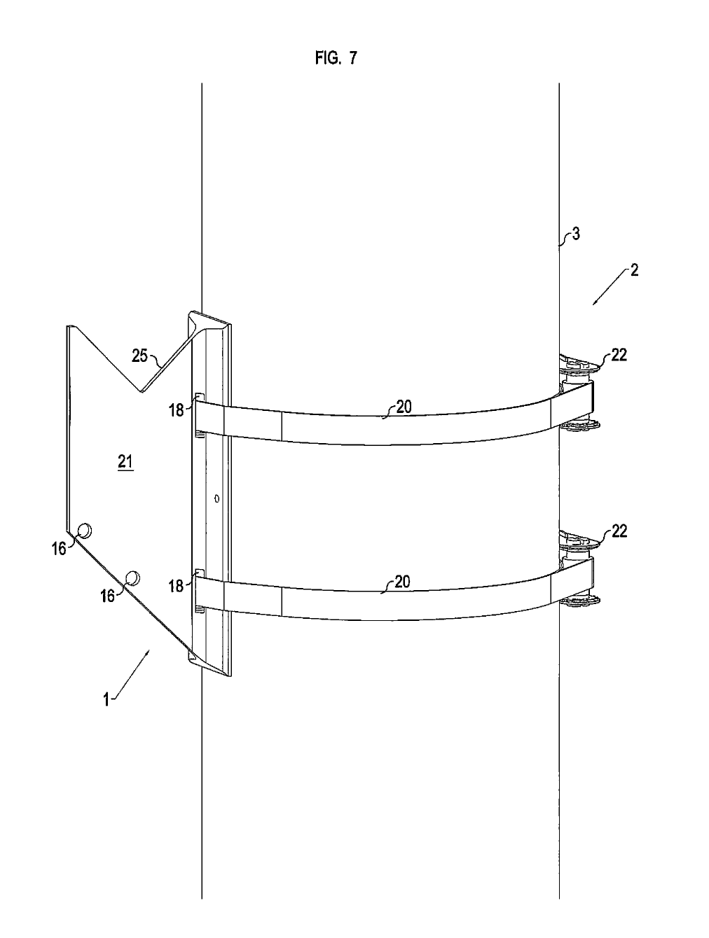

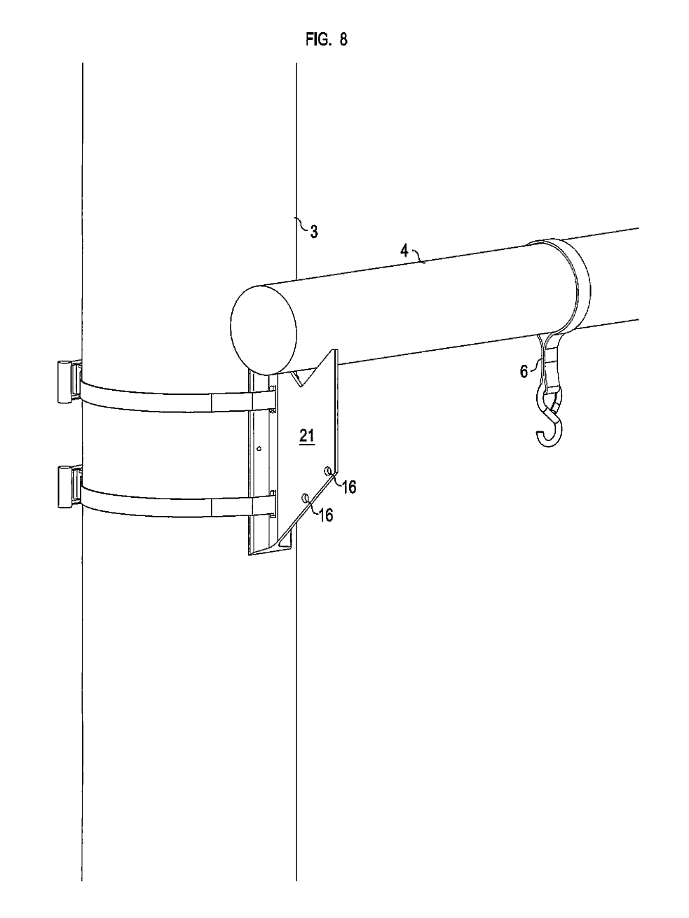

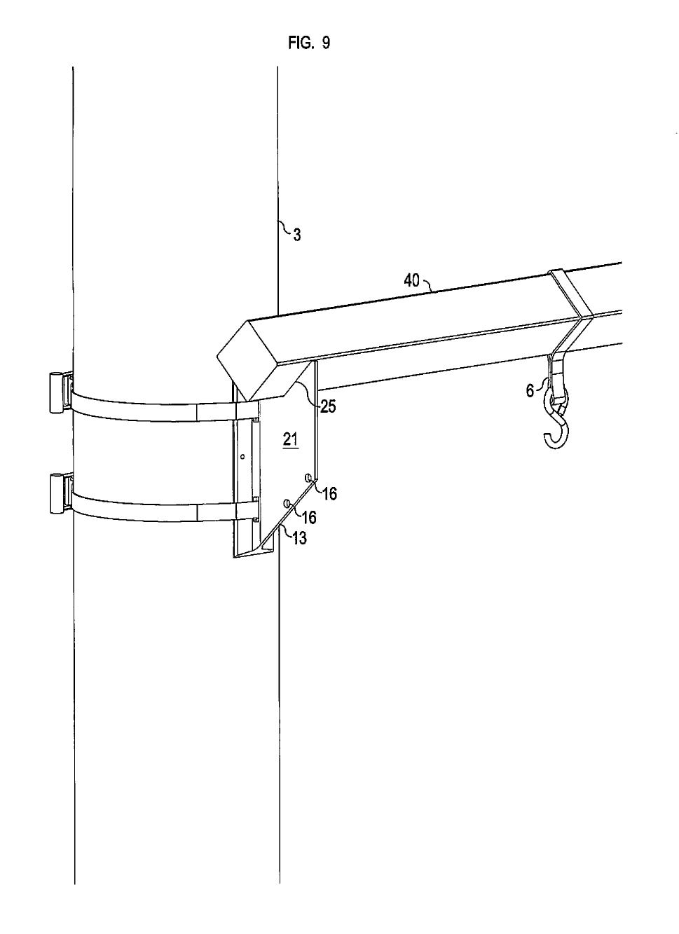

FIG. 6 shows two identical brackets with a V-shaped cross bar rest fastened securely on trees. The straps 20 have been inserted into the slots 18, around the tree and then into the ratchet 22. The ratchet is tightened to secure the bracket around the tree. The bracket assembly is shown in FIG. 8 supporting a round log 4. A strap hook 6 has been fastened around the log. The V-shaped bracket can be used to support a square beam 40 as shown on FIG. 9. Because of the right angle of the V-shaped cross bar rest, the square beam will not be able to roll. Any kind of chain, hook strap or gambrel can be attached to the cross bar.

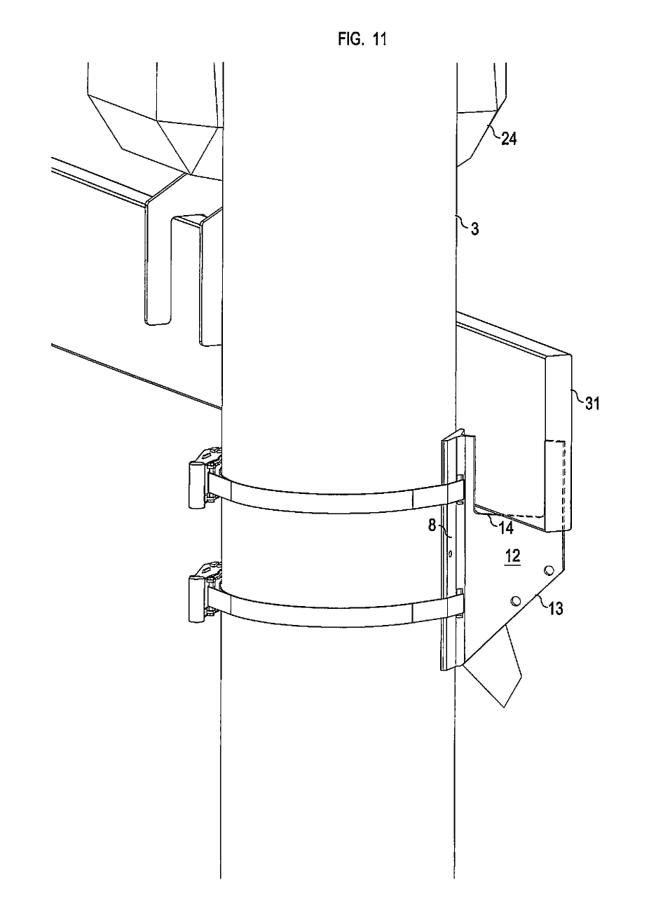

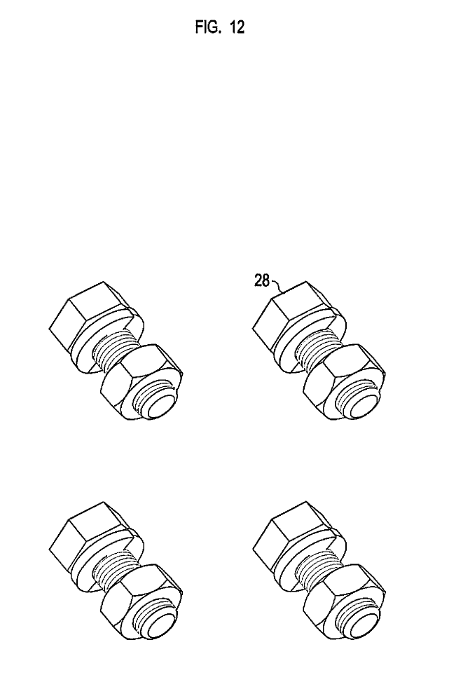

FIGS. 10 and 11 show a 2 inch by 6 inch rectangular beam 31 supporting an outboard motor 24 by means of a clamp 26. The bracket 1 has been secured against the tree 3 at a skewed angle in order to reduce the effective width of the U-shaped cross bar rest. The rectangular beam is thus prevented from sliding laterally or pivoting.

The cross bar can be either transported to the site or can be a tree that is cut down on site with a saw. Depending on the application, the bracket is placed at the desired height on a tree or on a pole. In order to do this, it is necessary to find two trees, poles or any combination thereof wherein that the distance between the two is short enough so that the two ends of the cross bar will extend beyond the cross bar rests. The strap 20 (preferably two straps) must be inserted into the slots 18 before placing the bracket against the tree. After the two brackets have been secured against the trees with the ratchets, the cross bar can be placed on the two cross bar rests. The assembled support is not injurious to the tree but is extremely strong. The support can even support an object as heavy as an all terrain vehicle. Also, the suspended beam construction permits a number of different objects to be suspended from the same beam at the same time.

It should be understood that the foregoing are merely exemplary of the preferred practice of the present invention and that various changes and modifications may be made without departing from the spirit and scope of the present invention, as defined in the appended claims.

I claim:

1. Portable support apparatus for supporting game or other objects above the ground between two adjacent, spaced vertical columns, comprising:
a set of at least two brackets, each bracket comprising:
a vertical back plate having front and back sides, the back side of the back plate abutting the vertical column;
a vertical support plate affixed along a rear edge thereof to the front side of the back plate at a position between two vertical side edges of said back plate and extending outwardly therefrom, said support plate having a recess in an upper edge that is shaped to function as a cross bar rest for a cross bar;
non-elastic straps for the brackets that engage the brackets and attach the brackets to separate support columns at a predetermined position above the ground, each strap being of sufficient length to encircle vertical columns of varying diameters and including a latching buckle for tightening the strap around a vertical column; and
a cross bar that extends between the brackets and rests in the cross bar rests in the brackets, the cross bar supporting objects suspended from the crossbar.

2. Portable support apparatus as in claim 1 wherein at least two straps are used to hold each bracket to a vertical column.

3. Portable support apparatus as in claim 1 wherein studs with protruding ends are mounted on the back plate, such that the protruding ends engage the support columns and resist downward slipping of the support bracket on the pole.

4. Portable support apparatus as in claim 1 wherein the cross bar rest has a rectangular U shape, with side edges of the cross bar rest being spaced apart sufficiently to permit the cross bar to rest between the side edges.

5. Portable support apparatus as in claim 4, wherein the cross bar is narrower than the space between the side edges of the cross bar rest, the bracket being mounted at a skewed angle on the vertical column such that the effective distance between the side edges in a direction perpendicular to the axis of the cross bar is reduced to the point where the cross bar fits relatively closely between the side edges so as to be supported thereby.

6. Portable support apparatus as in claim 1 wherein the cross bar rest is V-shaped.

7. Portable support apparatus as in claim 6 wherein the portion of the cross bar that rest on the cross bar rest is one of angular or rounded.

8. Portable support apparatus as in claim 7 wherein the cross bar is a log.

9. Portable support apparatus as in claim 7 wherein the cross bar is a rectangular beam.
